(19) United States
(12) Patent Application Publication
(10) Pub. No.: US 2018/0103232 A1
(43) Pub. Date: Apr. 12, 2018

(54) VIDEO TRANSMISSION SYSTEMS AND METHODS

(71) Applicant: FLIR Systems, Inc., Wilsonville, OR (US)

(72) Inventor: Theodore R. Hoelter, Santa Barbara, CA (US)

(21) Appl. No.: 15/709,224

(22) Filed: Sep. 19, 2017

Related U.S. Application Data
(60) Provisional application No. 62/405,855, filed on Oct. 7, 2016.

(51) Int. Cl. H04N 7/10; H04N 5/38; H04N 7/08; G06F 13/42; G06F 13/38

(52) U.S. Cl. CPC H04N 7/102; H04N 5/38; G06F 13/385; G06F 13/4282; H04N 7/08

(57) ABSTRACT

A system includes a video source providing an analog video signal, a data communications module, providing digital data communications, a USB-C port configured to receive a USB-C jack, and a board-to-cable device configured to map the analog video signal to sideband pins of the USB-C port, and map the digital data communications to the USB-C pins in accordance with a USB protocol. The a cable for use in the system may include a USB-C connector at a first end, an analog video portion coupled to sideband pins of the USB-C connector, and a digital data portion coupled to a subset of pins of the USB-C connector, the subset of pins selected in accordance with a USB protocol.

### CROSS-REFERENCE TO RELATED APPLICATIONS

This application claims the benefit of and priority to U.S. Provisional Patent Application No. 62/405,855 filed Oct. 7, 2016 and entitled “VIDEO TRANSMISSION SYSTEMS AND METHODS,” which is incorporated herein by reference in its entirety.

### TECHNICAL FIELD

The present application relates generally to video transmission to a client device. More specifically, the present invention relates to efficient use of system components to transmit analog video from a small footprint device.

### BACKGROUND

Providing analog video transmission from a small footprint device poses many design challenges. It is desirable to design a device, such as a security camera, that is small while maintaining robust functionality. There is therefore a need for improved systems and methods for analog video transmission in a small footprint device.

### SUMMARY

Systems and methods are disclosed for data communication and transmission of analog video from a single device. The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 is a high level block diagram illustrating an exemplary embodiment of a system providing analog video and data communications;

FIGS. 2A and 2B illustrate an exemplary embodiment of a communications cable in accordance with an exemplary embodiment of the present invention; and

FIG. 3 is a flow diagram illustrating an exemplary operation of a system in accordance with an exemplary embodiment of the present invention.

### DETAILED DESCRIPTION

In accordance with various embodiments of the present disclosure, systems and methods for processing and transmitting analog video are provided.

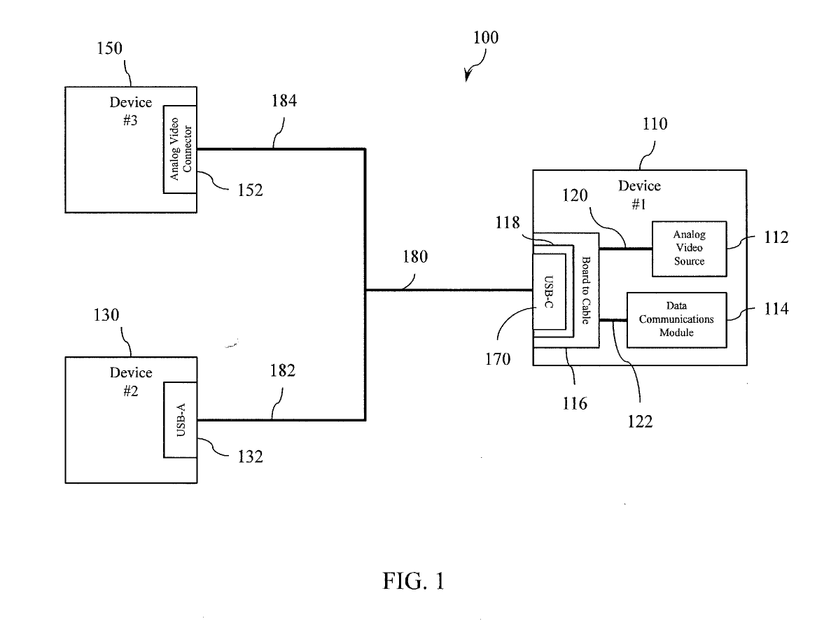

FIG. 1 illustrates an exemplary embodiment of a system providing analog video and data communications. The system 100 includes a first device 110, in communication with a second device 130 and a third device 150. The first device 110 includes an analog video source 112, a data communications module 114, a board-to-cable interface 116 and a USB-C port 118 for receiving a USB-C jack, such as USB-C connector 170.

In one embodiment, the board-to-cable interface 116 receives an analog video signal 120 from the analog video source 112 and transmits the signal to the sideband pins of the USB-C port 118. The board-to-cable interface 116 also receives digital communications data 112 from data communications module 114 and provides the digital communications data 112 to pins of the USB-C port 118 in accordance with a USB standard, such as USB-A.

A cable 180 communicatively couples device 110 to each of device 130 and device 150. On a first end, the cable 180 includes a USB-C jack 170 for receiving the analog video signal 120 and communications data 122 from the USB-C port 118. The cable 180 splits the wires coupled to the USB-C sideband pins from the remaining wires into a data communications portion 182 and an analog video portion 184. In one embodiment, the data communications portion 182 terminates at a USB-A connector 132, providing data communications between the first device 110 and the second device 130. The analog video portion 184 terminates with an analog video connector 152, providing an analog video signal to the third device 150.

In various embodiments, the first device 110 may be any device configured to provide an analog video signal 120 to an output through a USB-C communications port 118. In one embodiment, the first device 110 may be an image capture device, such as a surveillance video camera that may capture images in the visible, infrared or other waveforms. The second device 130 may be any device configured to communicate with the first device 110 through a USB interface. In one embodiment, the second device 130 is a server adapted to receive surveillance video data from the first device 110. The third device 150 may be any device configured to receive an analog video signal, such as a video monitor. In various embodiments, the second and third devices 130 and 150 may be combined in a single device, such as a computer system.

In various embodiments, the present disclosure allows for design of a device USB accessory board to maintain a small size. For example, a USB port in a camera may provide connection for power, digital video and control. In a conventional device, an additional port providing an analog video connection may require a larger design. In the exemplary embodiments, a USB-C connector is provided on one device, which feeds two separate connectors for a standard USB type A connection and an analog video connection.

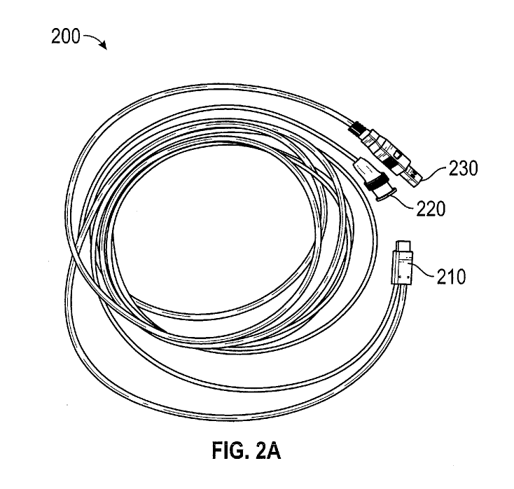

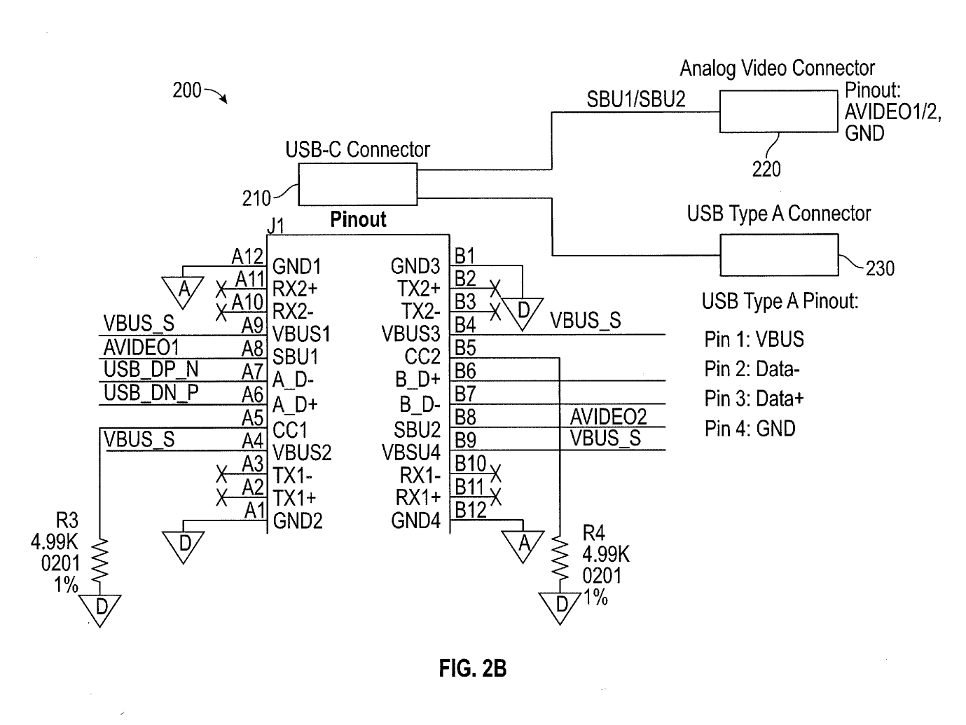

Referring to FIGS. 2A and 2B, an exemplary cable 200 in accordance with an exemplary embodiment of the present invention will now be described. A USB-C connector 210 includes 24 pins assigned in accordance with the USB-C standard. In one embodiment, a USB-C connector provides both a USB-A communications and an analog video signal. As illustrated, one or more sideband pins SBU1 and SBU2 are mapped to an analog video connector 220, which may be, for example, a BNC video connector. In one embodiment, the analog video connector 220 receives a composite video signal through the SBU1/SBU2 pins of the USB-C connector 210. A USB-A connector 230 includes 4 pins mapped to corresponding D+, D−, VBUS and GND pins of the USB-C connector.

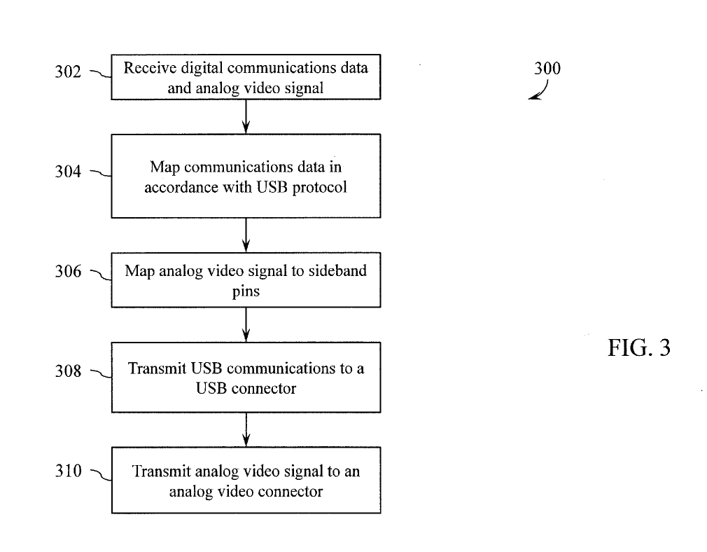

Referring to FIG. 3, an exemplary operation 300 of the embodiments illustrated in FIGS. 1 and 2 will now be described. In step 302, digital communications data and an analog video signal are received. The digital communications data is mapped to output pins in accordance with a USB protocol in step 304, while analog video signal is mapped to sideband pins in step 306. In step 308, the digital data is transmitted through USB-C output pins to a cable for output through a USB connector. In step 310, the analog video signal is transmitted through the USB-C output pins to a cable for output through an analog video connector.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for transmitting analog video and digital data comprising:
receiving an analog video signal;
receiving digital data;
transmitting the analog video signal through sideband pins of a USB-C port; and
transmitting the digital data through the USB-C port in accordance with a USB communications protocol.

2. The method of claim 1 wherein the analog video signal is a composite video signal.

3. The method of claim 1 further comprising transmitting the analog video signal and digital data through a single USB-C connector.

4. The method of claim 3 further comprising providing a communications cable coupled to the USB-C connector.

5. The method of claim 4 wherein the communications cable splits into a sideband portion and a digital data portion.

6. The method of claim 5 wherein the sideband portion is coupled at a terminal end to an analog video connector.

7. The method of claim 5 wherein the digital data portion is coupled at a terminal end to a USB connector.

8. A system comprising:
a video source providing an analog video signal;
a data communications module, providing digital data communications;
a USB-C port, configured to receive a USB-C jack; and
a board-to-cable device configured to map the analog video signal to sideband pins of the USB-C port, and map the digital data communications to the USB-C pins in accordance with a USB protocol.

9. The system of claim 8 wherein the video source is an image capture device.

10. The system of claim 8 wherein the analog video signal is a composite video signal.

11. The system of claim 8 further comprising a cable coupled to the USB-C port, the cable comprising:
a USB-C connector at a first end;
an analog video coupled to sideband pins of the USB-C connector; and
a digital data portion coupled to a subset of pins of the USB-C connector, the subset of pins selected in accordance with a USB protocol.

12. The system of claim 11 wherein the analog video portion includes an analog video connector at a terminal end.

13. The system of claim 11 wherein the digital data portion includes a USB connector at a terminal end.

14. A cable comprising:
a first end including a USB-C connector; and
a second end split into an analog video portion and a digital data portion, wherein the analog video portion is coupled to sideband pins of the USB-C connector, and wherein the digital data portion is coupled to a subset of pins of the USB-C connector in accordance with a USB protocol.

15. The cable of claim 14 wherein the analog video portion includes an analog video connector at a terminal end opposite the USB-C connector.

16. The cable of claim 14 wherein the digital data portion includes a USB-A connector at a terminal end opposite the USB-C connector.

17. A method of operating the cable of claim 16 comprising:
coupling the USB-C connector to a first device;
transmitting via the first device through the sideband pins of the USB-C connector, an analog video signal; and
transmitting via the first device through a subset of the remaining pins of the USB-C connector, digital data.

18. The method of claim 17 further comprising coupling the analog video connector to a second device, the second device receiving the transmitted analog video signal.

19. The method of claim 17 further comprising coupling the USB connector to a third device, the third device receiving the transmitted digital data.
